(19) United States
(12) Patent Application Publication
(10) Pub. No.: US 2024/0224828 A1
(43) Pub. Date: Jul. 11, 2024

(54) HAND WEEDER

(71) Applicant: Beyond CenterLine Solutions, Colorado Springs, CO (US)

(72) Inventor: Richard Michael Bond, Colorado Springs, CO (US)

(73) Assignee: Beyond CenterLine Solutions, Colorado Springs, CO (US)

(21) Appl. No.: 18/152,261

(22) Filed: Jan. 10, 2023

(51) Int. Cl. A01B 1/18

(52) U.S. Cl. CPC A01B 1/18

(57) ABSTRACT

An apparatus for gardening is disclosed. The apparatus may include a pair of elongated members pivotally connected to each other. Each elongated member may include a first body portion and a second body portion. The first body portion may include a handle grip and a cavity portion. The handle grip may be pivotally connected to the first body portion at a pivot point. Further, the handle grip may be configured to rotate about the pivot point to move between a handle grip closed position and a handle grip open position. Furthermore, the handle grip may be configured to be inserted into the cavity portion in the handle grip closed position. The apparatus may further include a plurality of teeth disposed on the second body portion. Each tooth may be inclined at a predefined angle relative to a second body portion longitudinal axis.

### TECHNICAL FIELD

The present disclosure relates to an apparatus for gardening, and more specifically to a hand weeder configured to remove weed or roots from ground.

### BACKGROUND

People use a variety of gardening tools to manage growth of vegetation around their houses, fields and lawns. For example, people use trowels, hoes, rakes, shovels, etc. to manage vegetation growth. In addition, some gardening tools are used as weeding tools to remove unwanted weed, wild grass, dandelions and crabgrass from lawns. Removal of unwanted weed and crabgrass may be beneficial for healthy growth of vegetation and for general upkeep of the lawns.

Conventional weeding tools may be bulky and may not be convenient for users to use or carry. For example, conventional weeding tools may have limited utility for a retail user who may desire to remove weed from small lawns or home gardens. Further, while conventional weeding tools may assist the user in removing weed from ground surface, the conventional weeding tools may not be efficient in removing weed that may have roots inside the ground.

Thus, there is a need for a weeding tool that may be convenient for users to use in smaller gardens/lawns and may assist the users in removing weed from inside the ground.

It is with respect to these and other considerations that the disclosure made herein is presented.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts a front view of an example apparatus in accordance with the present disclosure.

FIG. 2 depicts a side view of an apparatus bottom portion in accordance with the present disclosure.

FIG. 3 depicts a first example embodiment of a user using the apparatus of FIG. 1, in accordance with the present disclosure.

FIG. 4 depicts a second example embodiment of a user using the apparatus of FIG. 1, in accordance with the present disclosure.

FIG. 5 depicts another example apparatus in accordance with the present disclosure.

### DETAILED DESCRIPTION

### Overview

The present disclosure is directed towards an apparatus for gardening that facilitates a user to remove unwanted plantation from fields, lawns, etc. Specifically, the apparatus may be a hand weeding device or a hand weeder that the user may use with one hand (or both hands), and remove weed or roots from ground. The apparatus may include a pair of elongated members that may be pivotally connected with each other in a crisscross manner. For example, the pair of elongated members may be pivotally connected with each other in a “scissor-like” arrangement. Each elongated member may include a first portion (e.g., a top apparatus portion) and a second portion (e.g., a bottom apparatus portion) connected with each other. The first portion may include one or more handle grips and the second portion may include a plurality of teeth. The user may use the handle grips to “hold” the apparatus and pivotally move the pair of elongated members relative to each other. Specifically, the user may move the apparatus to an open position when the user moves the handle grips away from each other, and move the apparatus to a closed position when the user moves the handle grips towards from each other. The plurality of teeth disposed on second portions of opposing elongated members may move closer to each other when the apparatus is in the closed position, and may facilitate the user to grab/hold weed between the plurality of teeth. The user may further pull the weed from the ground when the weed is held between the plurality of teeth.

In some aspects, the first portion may include a first handle and a second handle. The first handle may be disposed at a first portion top end and the second handle may be pivotally attached to a first portion middle portion via a pivot point. The user may pivotally rotate the second handle from a closed position to an open portion (and vice-versa) based on user's requirement. In an exemplary aspect, the second handle may be in the closed position when a second handle longitudinal axis is parallel to a first portion longitudinal axis. Further, the second handle may be in the open position when the second handle longitudinal axis is perpendicular to the first portion longitudinal axis. The user may insert the apparatus into the ground by moving the second handle to the open position and “pushing” the second handle downwards.

In some aspects, second portion bottom end may be sharp or pointed, which may enable the user to easily insert the apparatus into the ground. Further, second portion edges and teeth edges may be blunt, which may ensure that the weed is not cut when the user holds the weed between the plurality of teeth. In an exemplary aspect, the teeth may be helical in shape and the second portion may be curved, which may further assist the user to conveniently hold the weed between the plurality of teeth.

The present disclosure discloses a hand weeder that is portable, lightweight and may be easily used by users of different physiologies. Further, the rotatable second handle enables the user to conveniently insert the apparatus into the ground and remove weed from inside the ground surface. Furthermore, blunt teeth edges ensure that the weed is not cut when the user pulls the weed from the ground.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

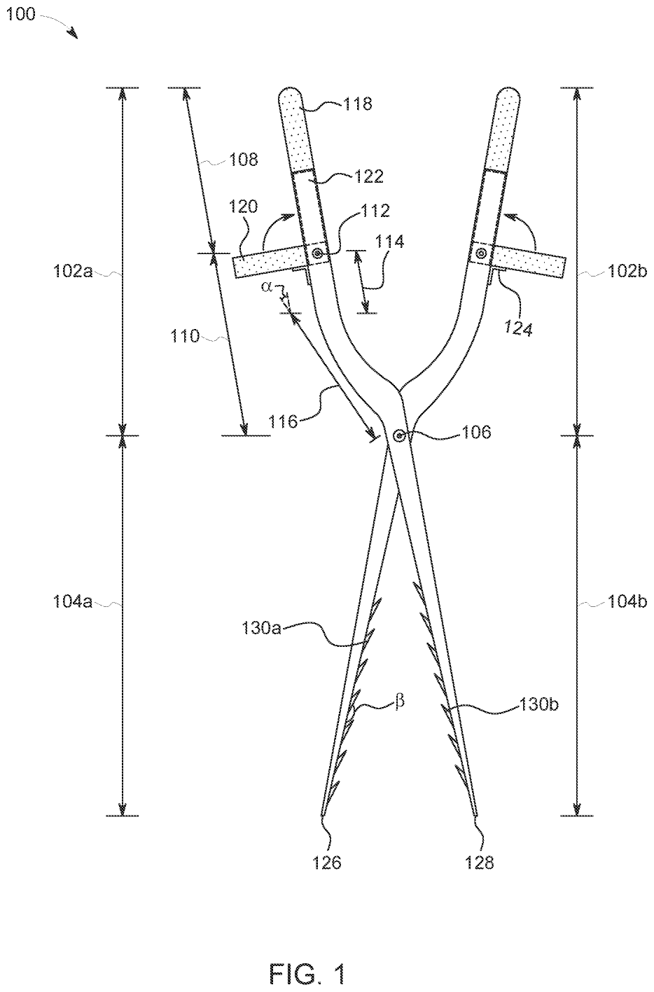

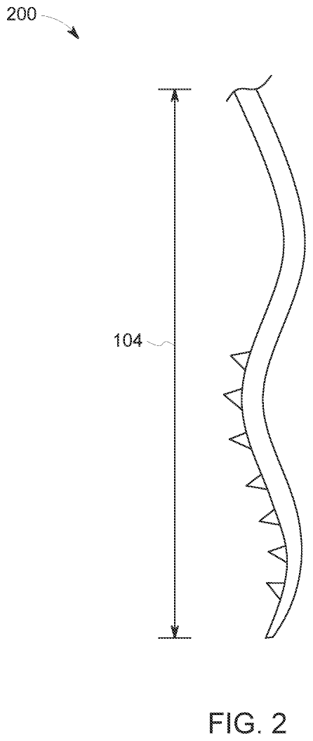

FIG. 1 depicts a front view of an example apparatus 100 in accordance with the present disclosure. While describing FIG. 1, reference may be made to FIGS. 2, 3 and 4. The apparatus 100 may be a gardening tool/apparatus, specifically a hand weeding tool or a hand weeder. Hereinafter, the apparatus 100 is referred to as the hand weeder 100.

A user (not shown in FIG. 1) may use the hand weeder 100 to remove unwanted plantation from ground. Specifically, the user may hold or grab the hand weeder 100 with one hand (or both hands) and remove unwanted weed, wild grass, dandelions, crabgrass, etc. from user's lawn or garden by using the hand weeder 100.

The hand weeder 100 may include a pair of elongated members having first body portions 102a, 102b (hereinafter referred to as a first body portion 102) and second body portions 104a, 104b (hereinafter referred to as a second body portion 104). The pair of elongated members may be pivotally connected with each other at a first pivot point 106, such that the pair of elongated members forms a “scissor-like” arrangement. Stated another way, the pair of elongated members may be pivotally connected with each other in a crisscross pattern. The user may rotate or move the pair of elongated members (e.g., the first body portions) towards each other to “close” the hand weeder 100 (e.g., move the second portions close to each other), and move the pair of elongated members apart to “open” the hand weeder 100. In particular, the hand weeder 100 may be in a closed position when the second body portions are moved towards each other, and in an open position when the second body portions are moved away from each other.

Each elongated member may be made of metal such as aluminum, steel, iron, and/or the like. Further, the elongated members may be coated with an anti-corrosive coating (e.g., Zinc coating). In an exemplary aspect, each elongated member may have a length in a range of 8-14 inches.

In some aspects, the first pivot point 106 may be disposed at an intersection point of the first body portion 102 and the second body portion 104. Stated another way, the pair of elongated members may be pivotally connected with each other at the intersection point of the first body portion 102 and the second body portion 104. The pivot point 106 may include a pivot rivet or a bolt-and-nut arrangement that may enable the pair of elongated members to be pivotally connected with each other.

The first body portion 102 and the second body portion 104 may form a unitary structure. In some aspects, a first body portion 102 length may be same as or equivalent to a second body portion 104 length. In other aspects, the first body portion 102 length may be less (or more) than the second body portion 104 length.

The first body portion 102 may have a cylindrical or cuboidal shape. In some aspects, the first body portion 102 may have a consistent diameter/thickness along a first body portion length, and may range from 0.5 to 2 inches. In other aspects, the first body portion 102 may have a tapered shape, such that a diameter/width of a first body portion proximal end (e.g., a first body portion top end) may be greater than a diameter/width of a first body portion distal end (which may be same as the intersection point/pivot point 106).

Each first body portion 102 may include a third body portion 108 and a fourth body portion 110. The third body portion 108 and the fourth body portion 110 may be connected with each other at an intersection point 112. A third body portion 108 length may be same as or equivalent to a fourth body portion 110 length. In other aspects, the third body portion 108 length may be less (or more) than the fourth body portion 110 length. Further, in some aspects, the third body portion 108 and the fourth body portion 110 may form a unitary structure.

The fourth body portion 110 may have a curved shape, as shown in FIG. 1. Specifically, a longitudinal axis of a fourth body portion proximal side 114 may be disposed at a predefined angle “α” relative to a longitudinal axis of a fourth body portion distal side 116. The angle “α” may be in a range of 20-45 degrees. Further, the longitudinal axis of the fourth body portion proximal side 114 may be parallel to a third body portion 108 longitudinal axis. In some aspects, the fourth body portions 110 may form “C-shape” in the open position (e.g., complete open position) of the hand weeder 100.

A fourth body portion 110 proximal end may be connected with a third body portion 108 distal end at the intersection point 112. In some aspects, each of the third body portion 108 may include a first handle grip 118, a second handle grip 120 and a cavity portion 122. The first handle grip 118 may be disposed at a third body portion 108 proximal side and the cavity portion 122 may be formed at a third body portion 108 distal side.

In some aspects, the first handle grip 118 and the second handle grip 120 may have same or equivalent lengths. In other aspects, the first handle grip 118 and the second handle grip 120 may have different lengths. For example, a first handle grip 118 length may be less (or more) than a second handle grip 120 length. Further, exterior surfaces of the first handle grip 118 and the second handle grip 120 may include foam so that it may be comfortable for the user to grip the first handle grip 118 and/or the second handle grip 120.

Cavity portion 122 dimensions may be same as or equivalent to second handle grip 120 dimensions. For example, if the first body portion 102 is cylindrical in shape, cavity portion 122 diameter and length may be same as or equivalent to second handle grip 120 diameter and length.

In some aspects, the second handle grip 120 may be pivotally connected with the third body portion 108 via the third body portion 108 distal end (i.e., the intersection point 112). Specifically, the intersection point 112 may be a second pivot point or hinged point that may enable the second handle grip 120 to pivotally connect with the third body portion 108 distal end. The second pivot point may be same as or similar to the first pivot point 106, and may include a pivot rivet or a bolt-and-nut arrangement.

The second handle grip 120 may be configured to rotate about the third body portion 108 distal end (i.e., the intersection point 112) to move from a second handle grip 120 closed position to a second handle grip 120 open position. Specifically, the second handle grip 120 may be in an open position when a second handle grip 120 longitudinal axis is perpendicular to a third body portion 108 longitudinal axis. Further, the second handle grip 120 may be in a closed position when the second handle grip 120 longitudinal axis is parallel to the third body portion 108 longitudinal axis.

The second handle grip 120 may be configured to be inserted into the cavity portion 122 when the second handle grip 120 is in the closed position. In some aspects, a cavity portion 122 interior surface and/or the intersection point 112 may include a locking mechanism (not shown) that may enable the second handle grip 120 to be locked inside the cavity portion 122 when the second handle grip 120 is in the closed position. The locking mechanism may include, for example, a ball-and-detent arrangement (or any other similar locking arrangement) that may enable the user to easily lock the second handle grip 120 in the closed position by “pushing” the second handle grip 120 into the cavity portion 122. In a similar manner, the user may pull the second handle grip 120 out of the cavity portion 122, and rotate the second handle grip 120 to move it to the open position.

The hand weeder 100 may further include a support structure 124 that may be disposed on each of the fourth body portion proximal side 114. In some aspects, the support structure 124 may be an L-shaped structure that may be disposed in proximity to the intersection point 112, and may enable the user to “rest” the second handle grip 120 on the support structure 124 when the second handle grip 120 is in the open position. In additional aspects, the locking mechanism included in the intersection point 112 may further assist the user to lock the second handle grip 120 in the open position.

As described above, the first body portion 102 and the second body portion 104 may be pivotally connected with each other at the first pivot point 106. Specifically, a fourth body portion 110 distal end may be connected with a second body portion 104 proximal end. In some aspects, the second body portion 104 may have a tapered shape, such that a second body portion 104 proximal end diameter/width may be greater than a diameter/width of second body portion distal ends 126, 128 as shown in FIG. 1. The second body portion distal ends 126, 128 may be sharp or pointed ends. In additional aspects, the second body portion distal end 126 may include a flattened interior surface that may “face” opposing flattened interior surface of the second body portion distal end 128. Stated another way, flattened interior surfaces of distal ends of the second body portions 104a, 104b may aligned parallel to each other.

In some aspects, the second body portion 104 may have a straight or flat elongated shape. In other aspects, the second body portion 104 may have a curved shape as shown in FIG. 2. Specifically, FIG. 2 depicts a side view 200 of a hand weeder 100 bottom portion in accordance with the present disclosure. The view 200 depicts an example side view of the second body portion 104. As shown in the view 200, the second body portion 104 may be curved and may have a double-S shape. In other aspects (not shown), the second body portion 104 may have a single-S shape, a Z-shape, a zigzag shape, or any other similar shape.

The second body portions 104a, 104b may include a plurality of teeth 130a, 130b (collectively referred to as a plurality of teeth 130) that may be disposed along a second body portion 104a, 104b interior surfaces, as shown in FIG. 1. In some aspects, the plurality of teeth 130 may have a serrated shape and may be inclined “upwards” towards the first body portion 102 at a predefined angle “β”. Stated another way, the plurality of teeth 130 may be inclined at the angle “β” relative to a second body portion 104 longitudinal axis. The angle “β” may be in a range of, for example, 30-60 degrees. Each tooth 130 may have a pointed or sharp tooth proximal end and a tooth distal end may be connected with the second body portion 104. A tooth proximal end diameter/width may be substantially less than a tooth distal end diameter/width.

In additional aspects, the plurality of teeth 130 may have helical shape (i.e., have a slight twist in the shape) so that opposing teeth 130a, 130b may interlock with each other when the opposing teeth 130a, 130b are in contact with each other or in proximity with each other, in the closed position. Further, in some aspects (not shown), the plurality of teeth 130 may be disposed along an entire length of the second body portion 104. In other aspects (as shown in FIG. 1), the plurality of teeth 130 may be disposed on a part of second body portion 104 length. For example, the plurality of teeth 130 may be present along 50-60% of the second body portion 104 length, and may be disposed closer to the second body portion distal ends 126, 128. Further, a count of teeth 130 may depend on the second body portion 104 length.

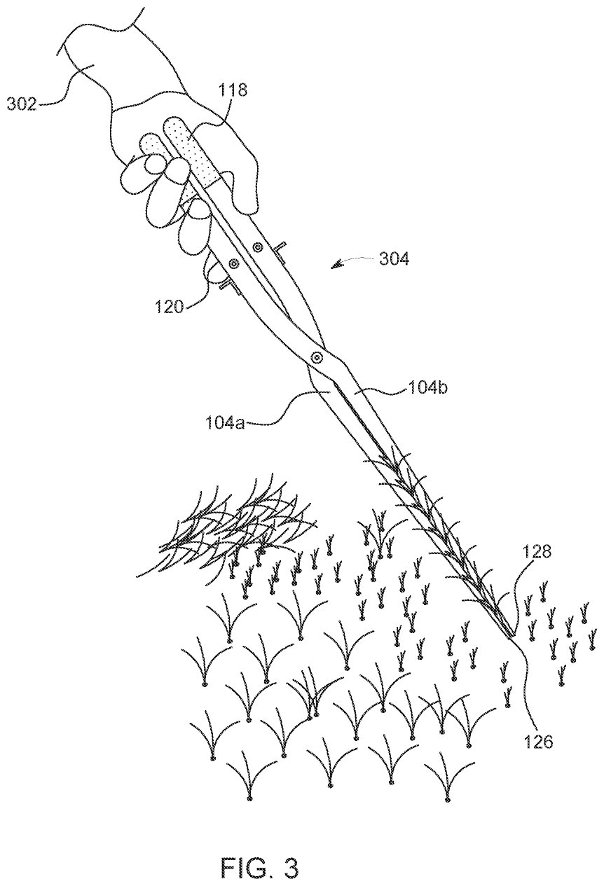

As described above, the hand weeder 100 may enable the user to remove unwanted plantation from ground. An example embodiment of a user using the hand weeder 100 is depicted in FIG. 3. Specifically, FIG. 3 depicts a first example embodiment of a user 302 using a hand weeder 304, in accordance with the present disclosure. The hand weeder 304 may be same as the hand weeder 100.

In one exemplary aspect of hand weeder 304 operation, the user 302 may rotate/move the second handle grip 120 to the closed position, and lock the second handle grip 120 in the cavity portion 122. The user 302 may then press the first handle grips 118 (and the second handle grips 120) of the pair of elongated members towards each other, which may result in the second body portion distal ends 126 and 128 to move towards each other. Specifically, the user 302 may press the first handle grips 118 towards each other to “close” the hand weeder 304. In a similar manner, the user 302 may move the first handle grips 118 away from each other to “open” the hand weeder 304. The second body portion distal ends 126 and 128 may move away from each other when the hand weeder 304 is in the open position. In some aspects, when the hand weeder 304 is in the open position, a distance between the second body portion distal ends 126 and 128 may be in a range of 1.5-4 inches. Further, the first handle grips 118 may be aligned parallel to each other when the hand weeder 304 is in the closed position.

The user 302 may close the hand weeder 100 to grab weed or roots between the plurality of teeth 130a, 103b, and pull the weed/roots from the ground. In some aspects, edges of the second body portions 104a, 104b and the plurality of teeth 130 may be blunt, which may ensure that the weed/roots are not cut by the edges of the teeth 130 and/or the second body portions 104a, 104b when the user 302 pulls the weed/roots.

A person ordinarily skilled in the art may appreciate that the helical shape and the upward inclined angle “β” of the plurality of teeth 130a, 130b may assist the user 302 to easily grab the weed/roots and pull them from the ground. Specifically, the helical shaped teeth 130a, 130b may interlock the weed/roots between the teeth 130a, 130b, which may result in a stable “hold” of the weed/roots. Further, the curved shape (e.g., S-shape) of the second body portion 104 may further assist the user 302 to grab a substantial volume of weed/roots between the teeth 130. Furthermore, the flattened interior surfaces of distal ends of the second body portions 104a, 104b may enable the user 302 to hold weed/roots between the flattened interior surfaces, and move the weed/roots from a first position (e.g., ground) to a second position (e.g., a bin, not shown).

In some aspects, the hand weeder 304 may be portable and lightweight, and the user 302 may easily carry the hand weeder 304 to different parts of user's lawn or garden without substantial manual effort. The user 302 may move the hand weeder 304 from open to close position (and vice-versa) iteratively, and remove weed/roots from different parts of the user's lawn or garden.

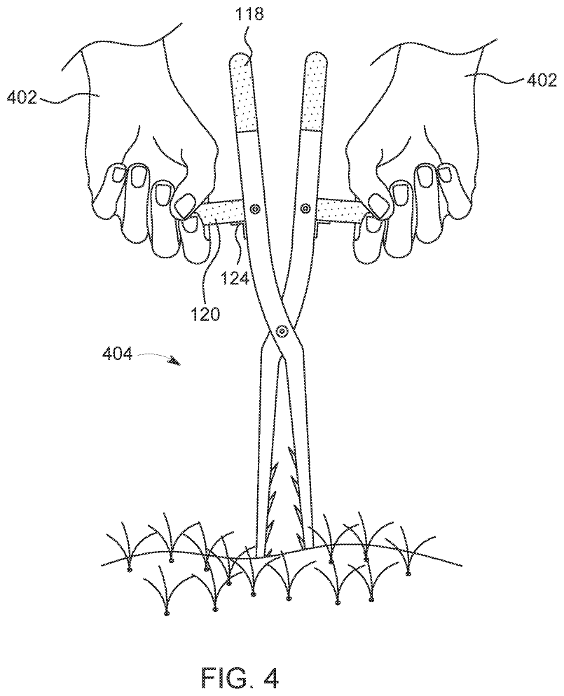

Another exemplary hand weeder usage is depicted in FIG. 4. Specifically, FIG. 4 depicts a second example embodiment of a user 402 using a hand weeder 404 in accordance with the present disclosure. The hand weeder 404 may be same as the hand weeder 100, 304.

The user 402 may rotate/move the second handle grip 120 to the open position, and rest the second handle grip 120 on the support structure 124. The user 402 may then insert the hand weeder 404 into the ground by pushing the second handle grip 120 downwards towards the ground. The sharp or pointed second body portion distal ends 126, 128 may enable the user 402 to easily insert the hand weeder 404 into the ground.

The user 402 may iteratively open and close the hand weeder 404 by using the first handle grips 118 (as described above in conjunction with FIG. 3) when the hand weeder 404 is inserted into the ground, and remove (“pull out”) weed/roots that may be present inside the ground surface.

A person ordinarily skilled in the art may appreciate that pushing the second handle grip 120 downwards (e.g., when the second handle grip 120 is in the open position) assists the user 402 in conveniently inserting the hand weeder 404 into the ground. The user 402 may move the second handle grip 120 back to the closed position when the hand weeder 404 is inserted into the ground, and remove weed/roots from inside the ground surface by using the first handle grips 118. Alternatively, the user 402 may continue to use the hand weeder 404 to remove weed/roots from inside the ground surface, while the second handle grip 120 is the open position. Stated another way, the user 402 may use the hand weeder 404 to remove weed/roots while keeping the second handle grip 120 in open or closed position.

Although FIGS. 1, 3 and 4 depict that the first handle grip 118 and the second handle grip 120 are shaped as straight rods, the present disclosure is not limited to the shape of the first and second handle grips 118, 120 as depicted in the FIGS. 1, 3 and 4. Further, in some aspects, the hand weeder 100, 304, 404 may not include the second handle grip 120. In this case, the hand weeder 100, 304, 404 may not include the cavity portion 122 as well. In yet another aspect, the hand weeder 100, 304, 404 may not include the first handle grip 118. In this case, the user may use the rotatable second handle grip 120 to open and close the hand weeder 100, 304, 404 to hold weed/roots between the plurality of teeth 130.

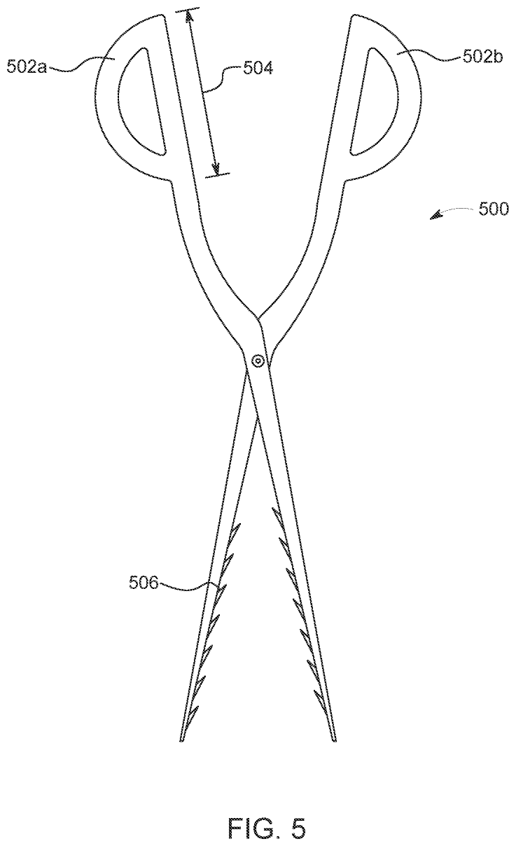

A different embodiment of a hand weeder is depicted in FIG. 5.

FIG. 5 depicts another example apparatus 500 in accordance with the present disclosure. The apparatus 500 may be a hand weeder, which may be similar to the hand weeder 100. Hereinafter, the apparatus 500 is referred to as the hand weeder 500.

In some aspects, the hand weeder 500 may not include the second handle grips 120. Instead, the hand weeder 500 may include semi-circular shaped handle grips 502a, 502b (hereinafter referred to as a handle grip 502) that may be rigidly affixed to third body portions 504 (same as the third body portion 108).

A handle grip 502 diameter may be same as a third body portion 504 length. The handle grip 502 may include foam to make it comfortable for a user (e.g., the user 302) to grip the handle grip 502.

In an exemplary aspect, the user 302 may insert thumb in one handle grip 502a and a finger in the second handle grip 502b, and move thumb and finger iteratively to close or open the hand weeder 500. For example, the user 302 may close or open the hand weeder 500 like the user 302 may operate scissors.

Similar to hand weeder 100 operation, opening and closing of the hand weeder 500 may assist the user 302 in grabbing and removing weed/roots from the ground by using a plurality of teeth 506 (same as the plurality of teeth 130).

Remaining hand weeder 500 elements are same as hand weeder 100 elements, and hence are not described here again for the sake of simplicity and conciseness.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc., should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. An apparatus comprising:
a pair of elongated members pivotally connected to each other, wherein each elongated member comprises a first body portion and a second body portion; and
a plurality of teeth disposed on the second body portion, wherein each tooth is helical in shape and inclined upwards at a predefined angle relative to a second body portion longitudinal axis.

2. The apparatus of claim 1, wherein the first body portion and the second body portion form a unitary structure.

3. The apparatus of claim 1, wherein the pair of elongated members is pivotally connected to each other at an intersection point of the first body portion and the second body portion.

4. The apparatus of claim 1, wherein the first body portion comprises a third body portion and a fourth body portion connected to each other.

5. The apparatus of claim 4, wherein the fourth body portion has a curved shape.

6. The apparatus of claim 4, wherein a fourth body portion distal end is connected to a second body portion proximal end.

7. The apparatus of claim 4, wherein the third body portion comprises a first handle grip, a second handle grip and a cavity portion.

8. The apparatus of claim 7, wherein the first handle grip is disposed at a third body portion proximal side.

9. The apparatus of claim 7, wherein the second handle grip is pivotally connected to the third body portion at a third body portion distal end.

10. The apparatus of claim 9, wherein the second handle grip is configured to rotate about the third body portion distal end to move between a second handle grip closed position and a second handle grip open position.

11. The apparatus of claim 10, wherein a second handle grip longitudinal axis is perpendicular to a third body portion longitudinal axis in the second handle grip open position, and wherein the second handle grip longitudinal axis is parallel to the third body portion longitudinal axis in the second handle grip closed position.

12. The apparatus of claim 11, wherein the second handle grip is configured to be inserted into the cavity portion in the second handle grip closed position.

13. The apparatus of claim 12, wherein second handle grip dimensions are equivalent to cavity portion dimensions.

14. The apparatus of claim 4, wherein third body portions of the pair of elongated members are disposed parallel to each other.

15. The apparatus of claim 1, wherein the second body portion is S-shaped.

16. The apparatus of claim 1, wherein a second body portion distal end comprises a flattened interior surface.

17. The apparatus of claim 16, wherein flattened interior surfaces of the pair of elongated members are parallel to each other.

18. An apparatus comprising:
a pair of elongated members pivotally connected to each other, wherein:
each elongated member comprises a first body portion and a second body portion,
the first body portion comprises a handle grip and a cavity portion,
the handle grip is pivotally connected to the first body portion at a pivot point,
the handle grip is configured to rotate about the pivot point to move between a handle grip closed position and a handle grip open position, and
the handle grip is configured to be inserted into the cavity portion in the handle grip closed position; and
a plurality of teeth disposed on the second body portion.

19. The apparatus of claim 18, wherein a handle grip longitudinal axis is perpendicular to a first body portion longitudinal axis in the handle grip open position, and wherein the handle grip longitudinal axis is parallel to the first body portion longitudinal axis in the handle grip closed position.

20. An apparatus comprising:
a pair of elongated members pivotally connected to each other, wherein:
each elongated member comprises a first body portion and a second body portion,
the first body portion comprises a handle grip and a cavity portion,
the handle grip is pivotally connected to the first body portion at a pivot point,
the handle grip is configured to rotate about the pivot point to move between a handle grip closed position and a handle grip open position, and
the handle grip is configured to be inserted into the cavity portion in the handle grip closed position; and
a plurality of teeth disposed on the second body portion, wherein each tooth is helical in shape and inclined at a predefined angle relative to a second body portion longitudinal axis.
